(19) United States
(12) Patent Application Publication
(10) Pub. No.: US 2026/0247329 A1
(43) Pub. Date: Aug. 20, 2026

(54) PROVIDING LOCATION INFORMATION FOR SENSING EVENTS

(71) Applicant: LENOVO (SINGAPORE) PTE. LTD., Singapore (SG)

(72) Inventors: Dimitrios Karampatsis, Ruislip (GB); Emmanouil Pateromichelakis, Viersen (DE)

(73) Assignee: LENOVO (SINGAPORE) PTE. LTD., Singapore (SG)

(21) Appl. No.: 19/156,174

(22) PCT Filed: Apr. 21, 2023
(86) PCT No.: PCT/EP2023/060452

§ 371 Date: Aug. 13, 2025

(30) Foreign Application Priority Data
Feb. 17, 2023 (GR) 20230100144

(51) Int. Cl. H04W 64/00

(52) U.S. Cl. CPC H04W 64/00

(57) ABSTRACT

The invention provides a functionality for exposing sensing services and location services at an area of interest offered by a 3GPP network. Therefore, the invention provides telecommunications network apparatuses for implementing a sensing function, a location management function and an access and mobility function, respectively. The sensing function is configured to provide sensing events of a sensing event type specified in sensing requirement parameters of a sensing request. The location management function is configured to provide location information based on the sensing requirement parameters. The access and mobility function is configured to interact with the sensing function and the location management function and to aggregate information from the functions based on a sensing correlation identifier.

### BACKGROUND

3GPP currently studies use cases and requirements to support sensing utilizing the New Radio (NR) cellular radio with aim at acquiring information about a remote object or environment and its characteristics without physically contacting it. The perception data of the object and its surrounding can be utilized for analysis. With this technique, meaningful information about the object or environment and its characteristics can be obtained.

The current definition of wireless 5G sensing, taken from 3GPP TR 22.837 is:

“5G Wireless sensing: 5GS feature providing capabilities to get information about characteristics of the environment and/or objects within the environment (e.g. shape, size, speed, location, distances or relative motion between objects, etc.) using NR RF signals and, in some cases, previously defined information available in EPC and/or E-UTRA.”

Most use cases of such sensing services address different target verticals/applications, e.g. autonomous/assisted driving, V2X, UAVs, 3D map reconstruction, smart city, smart home, factories, healthcare, maritime sector.

For example, sensing in smart home is one of the typical scenarios of indoor/local-area sensing. Considering people spends most of lifetime indoor, how to improve the user experience for indoor scenario is important. Current 5G networks allow user applications to employ various 5G UEs in various smart home platforms and environments. The UEs can be wearable devices, sensors, smart phones or a customer premise equipment (CPE). In order to enable a more comfortable and convenient indoor life, various of these devices can be connected via wireless signals to build a smart home platform.

In addition to communication purposes, wireless signals from various 5G UEs (e.g., wearable devices, sensors, smart phones, customer premise equipment (CPE), etc.) can also be used for sensing, e.g., monitoring the home environment continuously. For example, due to the activities of indoor objects or human, the 3GPP signal measured by UEs or the network would be influenced, allowing intruder detection in smart homes. By analyzing and collecting the sensing information such as Doppler frequency shift, amplitude change and phase change, the behavior of indoor objects or humans can be detected.

### SUMMARY

An aspect of the invention is to provide mobile telecommunications network apparatuses for implementing an improved sensing function, an improved location management function, and an improved access and mobility function.

According to an aspect, a mobile telecommunications network apparatus comprising a processor configured to execute computer-readable instructions for implementing a sensing function. The sensing function is configured to receive a sensing request. The sensing request comprises sensing requirement parameters, which comprise a sensing event type, a location area of interest, an indication to provide a location of the sensing event, and a corresponding location accuracy requirement. The sensing function transmits a sensing monitoring request to one or more sensing radio nodes to provide a sensing measurement based on the sensing event type. The sensing monitoring request comprises the sensing event type and a sensing correlation identifier. Then, the sensing function transmits a location request to a network function for initiating location specific measurements in serving the location area of interest when the one or more sensing radio nodes identify a sensing event based on the sensing event type. The location request comprises the sensing correlation identifier and the location accuracy requirement. The sensing function aggregates the sensing measurements from the one or more sensing nodes and location information based on location specific measurements from the one or more sensing nodes. Aggregating comprises correlating the sensing measurements and the location information based on the sensing correlation identifier. The sensing function validates that the sensing measurements correspond to the sensing event type and transmits a response based on the sensing measurements and the location information.

According to a further aspect, a mobile telecommunications network apparatus comprising a processor configured to execute computer-readable instructions for supporting location management. The apparatus receives a location request from a network function to provide a location specific measurement when one or more sensing radio nodes identify a sensing event based on a sensing event type. The location request comprises a sensing correlation identifier and a location accuracy requirement. The apparatus transmits location measurement instructions to each of the one or more sensing radio nodes. The location measurement instructions comprise the sensing correlation identifier and the location accuracy requirement. Then, the apparatus receives a location specific measurement from the one or more sensing radio nodes. The apparatus determines location information of a sensing event based on the location specific measurement and according to the location accuracy requirements and transmits a response to the network function based on the location information, wherein the response comprises the sensing correlation identifier.

According to a further aspect, a mobile telecommunications network apparatus comprising a processor configured to execute computer-readable instructions for implementing an access and mobility function (AMF). The AMF receives a sensing request. For example, the sensing request may be received from a gateway function. The sensing request comprises sensing requirement parameters. The sensing requirement parameters comprise a sensing event type, a location area of interest, an indication to provide a location of the sensing event, and a corresponding location accuracy requirement. The AMF discovers a function for location management and a function for sensing that serve the location area of interest. Then, the AMF transmits a sensing monitoring request to provide a sensing measurement based on the sensing event type. The sensing monitoring request comprises the sensing event type and a sensing correlation identifier. The AMF transmits a location request provide a location specific measurement when one or more sensing radio nodes identify a sensing event based on the sensing event type. The location request comprises the sensing correlation identifier and the location accuracy requirement. The AMF then aggregates sensing information and location information. Aggregating comprises correlating the sensing measurements and the location information based on the sensing correlation identification. The AMF then transmits a response based on the sensing measurements and the location information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments and aspects of the invention will be described in the following description and together with the accompanying drawings, wherein

FIG. 1 is a diagram showing a 3GPP network providing sensing services;

FIG. 2 is a diagram showing an exemplary basic architecture diagram for supporting sensing services within 3GPP network;

FIGS. 3a and 3b are an exemplary flow diagram of a sensing measurement and location request from an application function to a 3GPP network; and

FIGS. 4a and 4b are an alternative exemplary flow diagram of a sensing measurement request and location request from an application function to a 3GPP network using a gateway function.

### DETAILED DESCRIPTION

Reference will now be made in detail to the exemplary embodiments, examples of which are illustrated in the accompanying drawings.

The 3GPP started discussing use cases and potential requirements for localized metaverse services. The metaverse is an open, shared, and persistent virtual world that offers access to the 3D virtual spaces, solutions, and environments created by users. The metaverse is a digital reality that combines aspects of social media, online gaming, augmented reality (AR), virtual reality (VR), and cryptocurrencies to allow users to interact virtually. Some use cases can be the following:

### 1. Mobile Metaverse Based Selective Multi-Modal Feedback Service

Mobile metaverse based multi-modal feedback service describes a case of multi-physical entities or their digital avatars interacting with each other. New feedback modalities are also introduced in this use case to satisfy new scenarios and requirements in the mobile metaverse. The mobile metaverse may be a cyberspace parallel to the real world, which makes the virtual world more real and makes the real world richer. The service should better utilize different feedback cues and achieve multi-modal feedback cues to adapt to different scenarios, satisfy the accuracy of the task and user experience, and so on. More modalities should be explored to meet more immersion requirements of the physical entities in the real world such as smell and taste. To realize a more immersive requirement of different scenarios in the mobile metaverse, it is important to explore these temporal in-sync or out-of-sync boundaries for audio, video, haptic, scent, taste, and so on.

The mobile metaverse based multi-modal feedback service may be deployed at the edge/cloud server for different scenarios. During the application running period, the physical entities may achieve an immersive experience with their avatars, and the multi-modal feedback data may be exchanged with each other, whether the physical entities are in proximity or non-proximity.

### 2. Mobile Metaverse for 5G-Enabled Traffic Flow Simulation and Situational Awareness

With support of 5GS, real-time information and data about the real objects can be delivered the virtual objects of the road infrastructure and traffic participants including vulnerable road users who can form a smart transport metaverse. Real-time processing& computing can be conducted to support traffic simulation and also situational awareness and real time path guidance and real-time safety, or security alerts can be generated for ICVs as well as the driver and passengers.

To support traffic flow simulation and situational awareness service, the 5G network needs to provide low latency, high data rate and high reliability transmission, and in addition, the 5G network may also need to be further enhanced to meet the service requirements for 5G-enabled traffic flow simulation and situation awareness. Meanwhile, in addition to the real objects which may host the UE for cellular system, their corresponding virtual objects are also capable of interacting with each other and interact with physical objects via 5GS.

### 3. Spatial Mapping and Localization Service Enabler Use Case

A service provider or operator needs to provide and use spatial map information, i.e. a 3D map of indoor or outdoor environment. This use case considers how a spatial map can be created and employed, both as service enablers. The creation and maintenance of the spatial map is referred to as Spatial Mapping Service and the employment of the map to identify the customer's Localization is termed Spatial Localization Service.

Spatial mapping will classify objects into modelling and tracking of stationary and moving objects. For stationary object, spatial mapping has to estimate the number of objects, type of object and position. Whereas for moving objects, spatial mapping has to determine the position, type of object, direction, speed. Once the spatial mapping service has sufficient information, it has to map all the stationary and moving objects related to UE's environment. This information may be provided to the UE, service providers and surrounding subscribed users.

It may be a difficult task to perform the mapping of the entire city using a vehicle by traversing various roads and spaces. It also may require a lot of time and effort (for data conversion, etc.) if the work is performed offline. If multiple capturing devices are used in parallel, the spatial map data in the same location could be synthesized over different cameras and input devices to generate the spatial map.

A mobile capturing device, a vehicle or a robot equipped with multiple stereo/mono RGB cameras and multiple LiDAR sensors may be used to capture various qualities of images and depth information of the environments. As an example, a mobile indoor robot may be equipped with two LiDARs, six industrial cameras and four smartphone cameras.

For all scenarios, sensor data are required at the application provider side (e.g. a metaverse application server), which may include sensor data from multiple sources and multiple technologies. There can be a variety of sensing that can be used according to the device capabilities:
Non-3GPP-based sensors like radar, camera and Lidar sensors, UWB
NR-based (New radio based) sensing, where the UE and BS senses for stationary and moving objects around the UE. This may involve using time-difference-of-arrival (TDoA), angle-of-arrival (AoA), angle-of-departure (AoD) measurements, RSSI etc.

At the same time, there may be device limitations (e.g. low power nodes) for performing sensing processing, access limitations (bandwidth, latency) for providing the sensing outputs via Uu interfaces, and also processing requirements to fuse/combine sensing data from multiple sources to derive e.g. a spatial map.

In addition, different application services may have different requirements in terms of required granularity and accuracy of sensing, and a way may be needed to make the sensing communication optimal so as to avoid wasting network resources.

Some example KPIs for media used for sensor information communication are the following:

| Sensor Type | Uplink KPI | |
|---|---|---|
| 3D Lidar | 30 | Mbps |
| Industrial RGB Camera | 16~800 | Mbps |
| Smart Phone Camera | 4~200 | Mbps |

As such, collecting real world data for providing an immersive metaverse is a crucial task. The present invention provides an approach of integrating 5G Wireless sensing technology to content providing systems. In particular, the present invention provides techniques for a third party to determine sensing services supported by a 3GPP network and allows requesting a sensing service comprising specific sensing requirements.

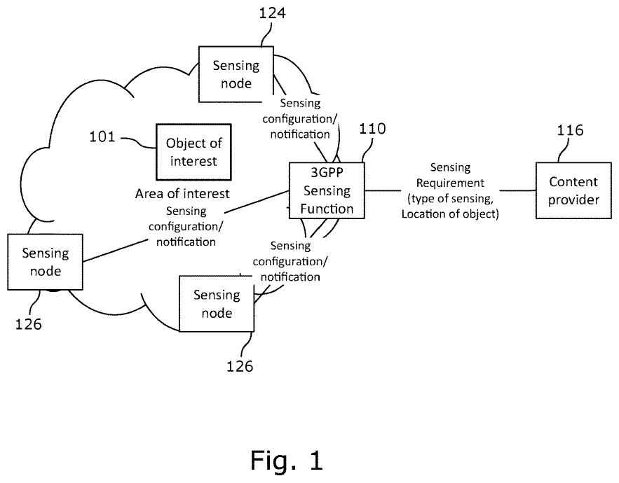

The claimed invention allows a third party application to be notified of a sensing event (or a specific sensing event type) in a particular area of interest utilizing the RF sensing capabilities of the 3GPP network as shown in FIG. 1.

A sensing event can be defined as the 3GPP network detecting an object using RF sensing measurement that meets certain sensing event type criteria. A sensing event type is a sensing event that meets certain sensing criteria (e.g. size of object, moving direction of object etc.). Each sensing event type may be identified by a specific sensing event type identifier. It is expected that the 3GPP network will standardize one or more sensing event types and corresponding identifiers.

In addition, a sensing request may include an indication to report the location of a sensing event of specific sensing event type with specific location accuracy requirements (either horizontal accuracy (in meters), vertical accuracy (in meters) or both.

According to FIG. 1, a content provider 116 as an application (such as a metaverse application) may submit a sensing request to a 3GPP sensing function 110. The sensing request may comprise specific sensing requirements, such as the type of sensing required (i.e. determine if a car is in a parking slot), the accuracy (or confidence of the sensing measurement), the accuracy of the location of the sensing event and the latency of responding a sensing event.

The 3GPP network may then identify which 3GPP-enabled sensing devices would be able support sensing measurements and report a sensing event of specific sensing event type at the particular location and select and configure such devices with sensing configuration in order to report the sensing event requested by the application. For example, the sensing function 110 in FIG. 1 may identify the sensing nodes (which may be sensing radio nodes 126 and/or a RAN 124 as described later) which are available in the area of interest to sense an object of interest 101. After selecting one or more sensing nodes 124/126, the sensing function 110 may send sensing configuration data to the selected sensing nodes 124/126 such that the sensing nodes operate appropriately and may sense the object of interest 101.

In addition, the sensing request may include an indication to report location of the sensing event. In such scenario, the 3GPP system needs to involve the a location management function (LMF) to configure the devices with information to report location measurements that assist in the determination of the location of the sensing event.

The present invention provides additional details on the 3GPP network to be able to identify which sensing nodes that support sensing capabilities can be used to assist in sensing measurements based on a sensing request by a third party.

Exemplary steps of the invention may be summarized as follows. A service requirement may be obtained from an XR/AI/Metaverse application. This requirement may include the required QoS/QoE for the service, the sensing event criteria in an area of interest, report location of the sensing event, etc. Thereafter, a (third party) application function may discover the sensing services supported by a 3GPP network, where a sensing service is identified by a sensing event type supported (e.g. identification of human, animal, size of object to be determined).

The (third party) application function may send a request to a function in the 3GPP network that supports a sensing service for the request. In this regard, information comprising a sensing event type, a location area, an accuracy of sensing, an indication to report location of the sensing event including location accuracy requirements may be included in the request.

Thereafter, the sensing function 110 in the 3GPP network may determine one or more sensing nodes 124 that can provide sensing information for the requested sensing event at the particular location where each node can be a RAN node, a sensing reference UE, or a UE. The sensing function 110 may send a configuration request to the identified node(s) to provide sensing information. The configuration may be an AI ML model or a pattern that needs to be reported. If the location of the sensing event is requested, the sensing function may send a request to a location management function (such as LMF 105 via GMLC 202 or via AMF 122) including an indication to report location of the sensing event.

The sensing function 110 may then collect sensing information from the identified nodes and location information from the LMF 105 (if requested) and may determine validity of the sensing measurements (e.g. type of object etc.) corresponding to the criteria of the sensing event requested by the third party.

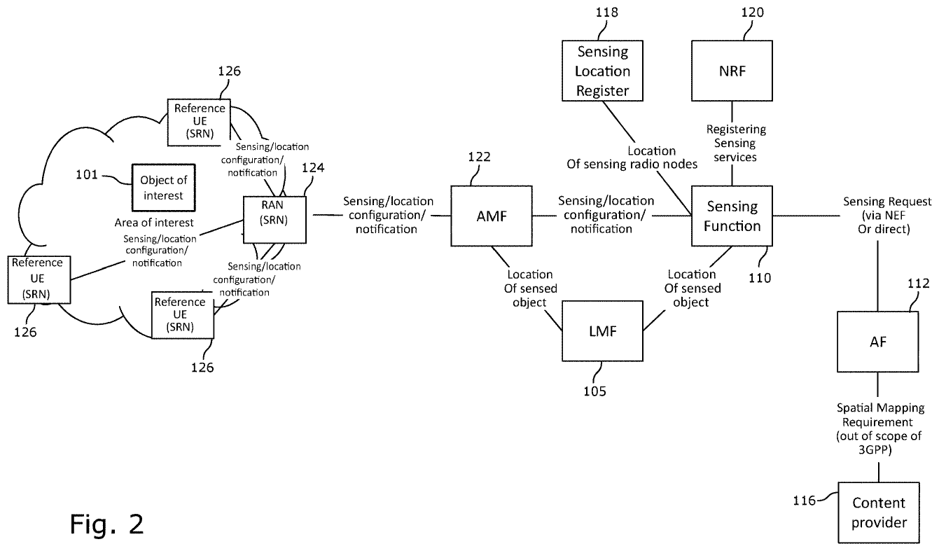

Additional details that may be required for implementing the third party application requests are shown in FIG. 2.

The sensing function 110 according to the claimed invention may supports the following:
it may handle all sensing requests;
it may identify and select the sensing radio nodes 124/126 that can assist in providing sensing event notifications for a sensing event type in a particular location. A sensing radio node can be a Reference UE 126 or a RAN node 124;
it may configure the sensing radio nodes 124/126 with the sensing event type notification required. The configuration may be an RF pattern to report or providing a trained AI model that assist the sensing radio nodes 124/126 to identify the object 101 based on the RF pattern detected or triggering the sensing radio node to use a specific ML model according to the sensing radio node reported ML model capabilities;
it may request the location management function (LMF) 105 (for example via GMLC 202 or AMF 122) to provide location information of a sensing event.
it may validate that the sensing event notifications provided by each sensing radio nodes 124/126 meets the criteria of the sensing event type requested by the third party 116.

The sensing function 110 may interface with a network repository function (NRF) 120 to register its sensing capabilities. The sensing capabilities may be an area of interest where sensing measurements can be provided and/or sensing event type(s) supported (e.g. sensing a pedestrian). Each sensing event type can be identified by a sensing event identifier.

The sensing function 110 may interface with the GMLC/LMF 105 to request a location of a sensing event after the sensing function 110 configures the selected radio nodes 126 to report measurements to identify the location of a sensing event. Such functionality may require the following:
An indication to provide sensing specific location measurements when a sensing event has taken place.
An Area of interest.
A sensing event type, i.e., report location measurements only if a specific sensing event type has taken place.

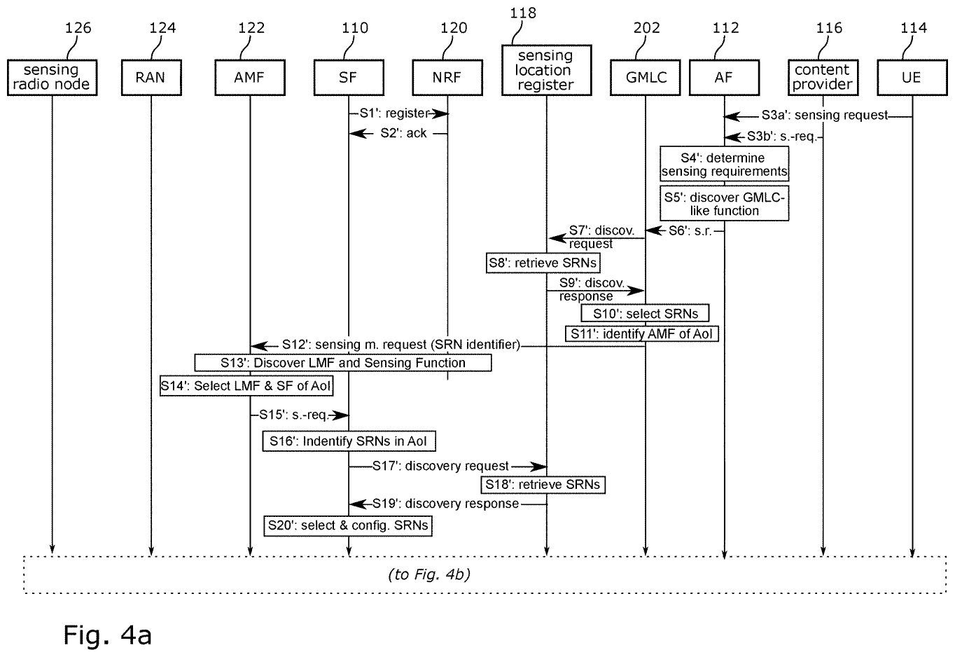

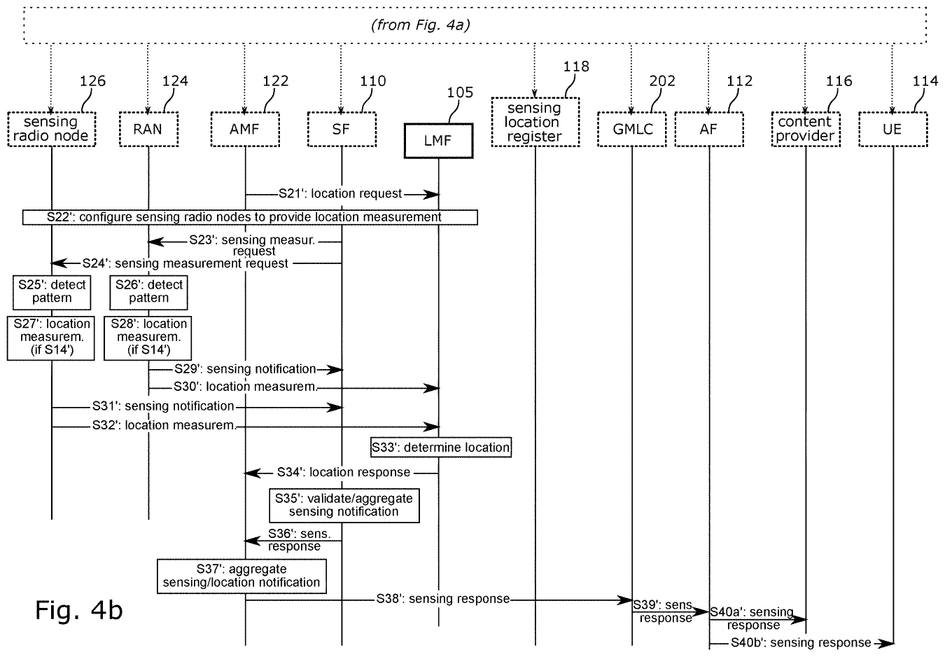

Alternatively, all sensing requests are sent to a gateway function (gateway mobile sensing and location-, GMLC-, like function) that handles both “legacy” location and sensing requests. The GMLC-like function may then request from the sensing function to report sensing information and from the LMF to provide location of a Sensing Event Type (if the sensing request includes an indication to provide location of a sensed object). Alternatively, the GMLC-like function may send the sensing request to the sensing function and the sensing function interfaces with the LMF if location of the sensing event is required. Further details of the variations are provided in the call flow in FIGS. 4a and 4b.

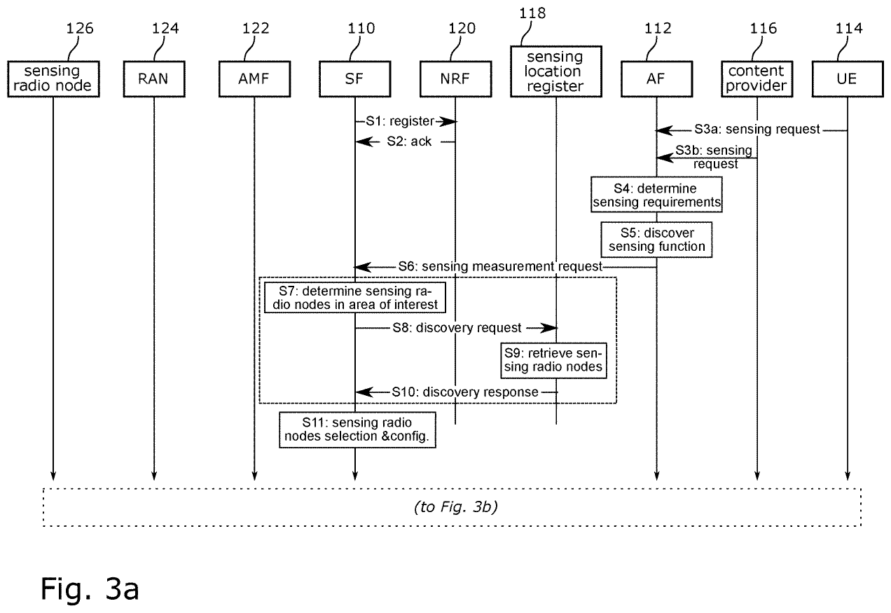

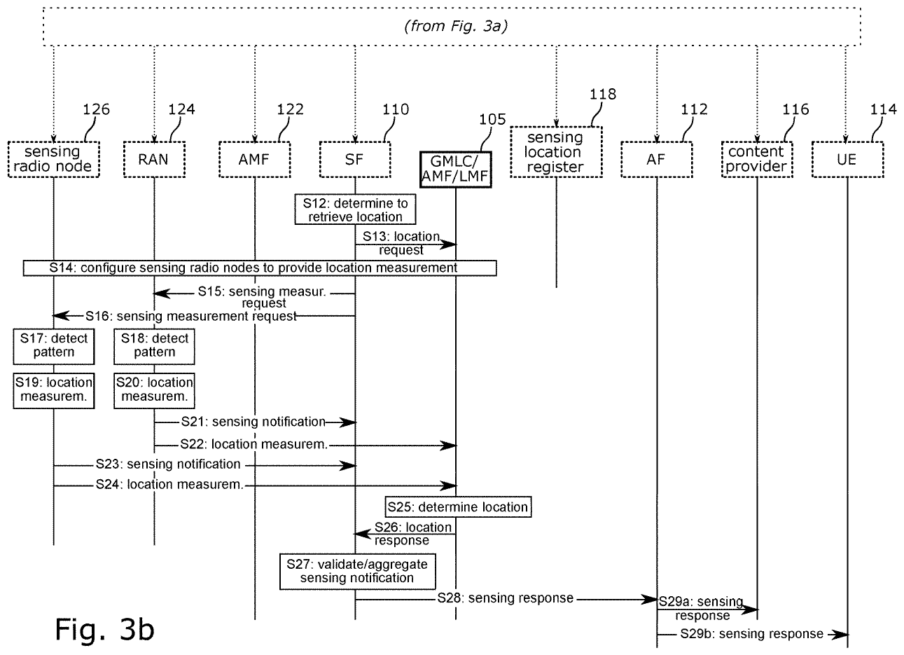

An exemplary procedure and flow of operations for providing a sensing measurement is shown in FIGS. 3a, 3b and 4a, 4b.

According to an embodiment, FIGS. 3a and 3b disclose an exemplary scenario, where an application function (AF) 112 is used for generating a sensing request for a sensing event of the 5G network.

A sensing function (SF) 110 may initially register its sensing capabilities to the network repository function (NRF) 120 in step S1. The sensing function 110 may be a network function that may be part of the 5G network. Exemplary capabilities of the sensing function (SF) 120 may comprise one or more of an area of interest (loE) where sensing measurement can be provided by the respective SF 110, a list of Sensing Event Type Identifiers handled or provided by the SF 110 and sensing accuracy provided by the SF 110. However, there may be additional parameters available that may be used in the registration process step S1. In step S2, the NRF 120 may optionally acknowledge the registration request of the SF 110.

Steps S1 and S2 may be regarded as optional pre-steps before a request for sensing is received.

In step S3 (S3a and S3b), a content provider 116 and/or a user via a user equipment (UE) 114 may require a sensing measurement from the application function (AF) 112. The sensing request may be for a specific use case and the AF 112 may be a third party application function. In step S4, the AF 112 may determine one or more sensing measurement requirements, which may include a sensing event type, an area of interest, an accuracy of sensing measurement, whether the location of the sensing event needs to be provided, and location accuracy requirements (horizontal and/or vertical for example in meters). However, the sensing requirements as described above may be exemplary and more or less sensing requirements may be determined by the SF 112.

After the AF 112 determines the requirements, the AF 112 may discover, in step S5, an appropriate sensing function that may be able to provide sensing events that conform the request from the content provider 116 or the UE 114. In the example of FIG. 3, it is assumed that the SF 110 is a sensing function that fulfils the requirements.

If the AF 112 is trusted the AF 112 may interface with the NRF 120 to discover the Sensing Function, such as SF 110 in step S5. Alternatively the AF 112 may contact a network exposure function (NEF, not shown) and the NEF may discover the sensing function on behalf of the AF 112 based on the requested sensing event.

Trusted means that the AF 112 may be part of the network and/or may be able and allowed to directly communicate with the different network functions provided by the network. If the AF 112 is not trusted, it may be limited in directly interacting with the network functions and may use/interface an NEF instead.

As will be later discussed with regard to FIG. 4, in an alternative embodiment, the request may be sent to a gateway mobile location centre-(GMLC-) like function that may handle location and sensing requests. The GMLC-like function may then send a request to the Sensing Function via an access and mobility function (AMF) 122. More details concerning this alternative scenario are shown in FIG. 4.

In step S6, the AF 112 may send a sensing request (or a sensing measurement request) to the Sensing Function SF 110 that has the sensing measurement requirements identified in step S4. In some cases, if the AF 112 is a third party, the request may be sent to the NEF (not shown) and the NEF forwards it to the SF 110 (the request may also be received via a GMLC-like function, as shown in FIG. 4). The sensing request (or sensing measurement request) may comprise one or more sensing requirement parameters. Exemplary sensing requirement parameters may be a sensing event type, a location area of interest, an accuracy of sensing, an indication to provide a location of the sensing event indication, and a corresponding location accuracy requirement. The request may comprise one or more of these parameters and may also comprise additional or other parameters. In an embodiment, the sensing request from the application function 112 may comprise more sensing radio node identities for reporting sensing events of a specific sensing event. In such case, the application function 112 may itself perform a sensing radio node discovery.

In step S7, the SF 110 may determine one or more sensing radio nodes 126 and/or radio access networks 124 that may be able to provide a sensing event notification according to the sensing measurement requirements in step S4 or as specified in the sensing requirement parameters. For example, each SRN 126 may comprise a specific sensing capability, which may include one or more AI ML models stored in the sensing radio node that support monitoring of one or more sensing event types. In the following, the description refers to sensing radio nodes (SRNs) 126 only, but it is to be understood that RAN 124 may always be an alternative to SRNs 126 and may likewise be used. The step S7 of determining SRNs in the Aol may comprise the sub-steps S8 to S10.

For example, in step S8, the SF 110 may interface with a sensing location register (SLR) 118 to discover sensing radio nodes and/or a RAN in the area of interest that may be able to provide a sensing event notification according the sensing event type requested. The sensing location register 118 may be a location management function (LMF), an access and mobility function (AMF) or a unified data management (UDM) that may have information on the location of the sensing radio nodes in the area of interest where sensing is requested. The discovery request may include an area of interest and a sensing event type. In an alternative embodiment each sensing radio node 126 or RAN 124 may register its sensing capabilities to the sensing function 110 directly. In such case the sensing function 110 may cover a specific area of interest.

In step S9, the sensing location register 118 may retrieve the sensing radio nodes (e.g. SRN 126 and/or RAN 124) that can assist in providing sensing measurement in the area of interest. The sensing location register 118 may respond with the requested information in step S10.

After discovering the appropriate SRNs 126, i.e. either by the procedure of steps S8 to S10 or via other mechanisms, such as each SRNs 126 registering itself at the sensing function 110, the sensing function 110 may select one or more SRNs 126 for providing a sensing measurement at step S11. According to an embodiment, the selection may simply include using all SRNs 126 as discovered in steps S8 to S10. In another embodiment, the selection of step S11 may include selecting the SRNs 126 based on their capabilities. The sensing function 110 may in some embodiments further determine the configuration for the SRNs 126 and/or the selected RAN 124. The Configuration may be a radio pattern to monitor or use a specific AI model for tracing RF measurements.

In step S12, if location of a sensing event is requested to the sensing function 110 (for example as in step S6) the sensing function 110 determines that a location management function (LMF) 105 needs to be involved in order to measure the location of a sensing event. Notably, the location function 105 may be any network function that supports location measurement services and does not necessarily be the LMF, but may be an access and mobility function or a gateway function that supports the location measurement. In the following the expression LMF is used as a generic expression for a network function that supports gathering location information. The sensing function 110 may find the LMF 105 that serves the area of interest. For example, the LMF may be identified based on the selected sensing radio nodes or the sensing function may send the request to the AMF or GMLC towards the LMF. In an alternative, the SF 110 may itself be the LMF 105 or support location management functionality. In this case, the SF 110 may not communicate with the LMF 105, but may perform the functionality of the LMF 105.

The sensing function 110 may send a location request in step S13. The location request may be received by the LMF 105 that serves the area of the selected radio nodes. The location request may include a new indication that a location measurement is needed only when a sensing event of specific event type took place. The location request may further include one or more of an area of interest and an accuracy of location measurement (e.g. in horizontal and/or vertical accuracy requirements in meters). The request may also include a sensing correlation identifier that allows the sensing function 110 to correlate sensing and location measurements.

In general, a location request may be a request for ranging (i.e. range from the sensor node) or a request for positioning (coordinates and height) with specific location accuracy (horizontal accuracy (in meters) or vertical accuracy (height in meters)). In addition, the location request may further include a request for measuring a speed and/or a direction of the object of interest. According to current version of standard 3GPP TR 22.837, an accuracy of positioning estimate is defines that describes the closeness of the measured sensing result (i.e. position) of the target object (object of interest) to its true position value. It can be further derived into a horizontal sensing accuracy-referring to the sensing result error in a 2D reference or horizontal plane, and into a vertical sensing accuracy-referring to the sensing result error on the vertical axis or altitude.

In step S14, the LMF 105 may send configuration information to the selected sensing radio nodes 126 and/or the RAN 124. The configuration information may include information to the sensing radio nodes 126 to provide location related measurements only when a sensing event has taken place. The request may include the sensing correlation identifier.

In steps S15 and S16, the sensing function 110 may send a sensing monitoring request to the selected SRNs 126 (and/or RAN 124). The request may include a specific ML model or the sensing type to report. This may include transmitting the corresponding configuration data determined in step S11 to the respective one or more SRNs 124/126 that have been selected for sensing. In addition, the sensing function 110 may transmit the sensing correlation identifier for the sensing monitoring request to the selected SRNs 126.

After receiving the sensing monitoring request from the sensing function 110, the SRNs 126/124 may detect a sensing event of the specific event type in steps S17 and/or S18. This may include applying the configuration data received from the sensing function 110 and operating according to the configuration data.

The sensing radio nodes may also perform location specific measurements in steps S19 and S20, if instructed by the LMF 105, if a sensing event of specific sensing event type took place. When the SRNs 126 identify a pattern, the sensing radio nodes 126 may report the measurement to the sensing function 110 in step S21 and/or S122. The sensing measurement may include the RF measurements collected. The information may include the sensing correlation identifier as described above.

In steps S23 and S24, the sensing radio nodes 126 may also provide location specific measurements to the LMF 105 if instructed by LMF 105. The information transmitted to the LMF 105 may include the sensing correlation identifier provided in step S14. After receiving the data from the SRNs 126, the LMF 105 may determine the location of the sensing event according to the location accuracy requirements received. Then, the LMF 105 may report the location of the sensing event to the sensing function 110. The report may include the sensing correlation identifier.

In step S27, the sensing function may aggregate the sensing measurements from the selected sensing radio nodes 126. The sensing function 110 may be able to correlate all sensing and location information using the sensing correlation identifier provided by the sensing radio nodes 126 and the LMF 105. The sensing function 110 may validate that the reported sensing measurement correspond to the sensing event type requested by the application function 112. The sensing function 110 may use an artificial intelligence (AI) model to validate the sensing measurement.

According to an embodiment, the validation may refer to a confidence level of the sensing result. For example, if the validation results in a positive validation, the sensing event may be with a high certainty (such as 95%) of the sensing event type that has been specified in the sensing request. If the validation results in a negative validation, the confidence level may be lower, such as 50% or less.

The sensing function 110 may then in step S28 report the sensing event of the sensing measurement and the location of the sensing event to the application function 112. The report in S28 may include an indication of accuracy of the location of the sensing event. The report may in some embodiments further include the confidence level that has been determined in step S27. The application function 112 may then forward the sensing measurement to the content provider 116 or the UE 114 in steps S29a and/or S29b.

An alternative procedure where a GMLC-like function handles both location and sensing request is shown in FIGS. 4a and 4b. The operational flow of FIGS. 4a and 4b is similar to the operational flow of FIGS. 3a and 3b, but contains some additional steps, additional functions and some of the operations may differ from FIGS. 3a and 3b.

A sensing function 110 may initially register its sensing capabilities to the network repository function (NRF) 120 in step S1′. The sensing function 110 may be a network function that may be part of the 5G network. Exemplary capabilities of the sensing function 120 may comprise one or more of an area of interest (loE) where sensing measurement can be provided by the respective SF 110, a list of Sensing Event Type Identifiers handled or provided by the SF 110 and sensing accuracy provided by the SF 110. However, there may be additional parameters available that may be used in the registration process step S1′. In step S2′, the NRF 120 may optionally acknowledge the registration request of the SF 110.

Steps S1′ and S2′ may be regarded as optional pre-steps before a request for sensing is received.

In step S3′ (S3a′ and S3b′), a content provider 116 and/or a user via a user equipment (UE) 114 may require a sensing measurement from the application function (AF) 112. The sensing request may be for a specific use case and the AF 112 may be a third party application function. In step S4′, the AF 112 may determine one or more sensing measurement requirements, which may include a sensing event type, an area of interest, an accuracy of sensing measurement, whether the location of the sensing event needs to be provided, and location accuracy requirements (e.g., horizontal and/or vertical in meters). However, the sensing requirements as described above may be exemplary and more or less sensing requirements may be determined by the sensing function 112. In some embodiments, the application function 112 may itself identify sensing radio nodes 126 in the area of interest.

After the AF 112 determines the requirements, the AF 112 may, in step S5′, discover a gateway function 202 that may be able to provide the sensing event. If the AF 112 is trusted the AF 112 may interface with the NRF 120 to discover the gateway function 202. Alternatively the AF 112 may contact a network exposure function first (NEF, not shown) and the NEF may discover the gateway function on behalf of the AF 112 based on the requested sensing measurement requirements. Trusted means that the AF 112 may be part of the network and/or may be able and allowed to directly communicate with the different network functions provided by the network. If the AF 112 is not trusted, it may be limited in directly interacting with the network functions and may use/interface an NEF instead.

The AF 112 sends, in step S6′, a sensing measurement request to the gateway function 202 that may include the sensing measurement requirements identified in step S4′. If the AF 112 is a third party, the request may be sent to the NEF and the NEF may forward the request to the gateway function 202. In some embodiments, the sensing measurement request may include a list of sensing radio node identifiers (e.g. GPSI).

In an embodiment, the sensing request from the application function 112 may comprise more sensing radio node identities for reporting sensing events of a specific sensing event. In such case, the application function 112 may itself perform a sensing radio node discovery.

If the sensing measurement request does not contain any information on sensing radio nodes 126 (or 124), the gateway function may interface with a sensing location register 118 in step S7′ to retrieve information of available sensing radio nodes 126 and/or RAN 124. The gateway function 202 may then send a discovery request to the sensing location register 118.

At this point, or in some embodiments even before that point, at step S8′, the sensing location register 118 may retrieve information about available SRNs 126 in the location of interest. In step S9′, the sensing location register 118 may provide a list of sensing radio nodes 124/126.

In step S10′, the gateway function 202 may select sensing radio nodes (i.e. one or more of the SRNs 126 and/or the RAN 124) that support the location and sensing request. For example, each SRN 126 may comprise a specific sensing capability, which may include one or more AI ML models stored in the sensing radio node that support monitoring of one or more sensing event types. According to an embodiment, the selection may simply include using all SRNs 126 as discovered. In another embodiment, the selection may include selecting the SRNs 126 based on their capabilities. If the above steps S7′ to S10′ occurred, the gateway function 202 may then in step S11′ discover the access and mobility function (AMF) 122 serving the area of interest for sensing and the selected sensing radio nodes. The gateway function 202 may discover and access and mobility function (AMF) 122 that serves the area of interest for sensing and location and the selected sensing radio nodes 126 (if steps S7′-S10′ took place) or the AF 112 may have provided a list of sensing radio node identifiers. If the location of a sensed object is requested, the gateway function 202 may determine that an LMF 105 may be required. In an alternative, the SF 110 may itself be the LMF 105 or support location management functionality. In this case, the AMF 122 110 may not transmit separate requests to the LMF 105 and the SF 110, but may transmit one request to the network function supporting both, sensing functionality and location measurement functionality.

In step S12′, the gateway function 202 may discover the AMF 122 serving the selected sensing radio nodes and sends a sensing and location request to the AMF 122. The sensing and location request may the same request or similar to the request that the gateway function 202 receives from the AF 112. Alternatively the gateway function 202 may send separate sensing and location requests to the AMF 122. The request from the gateway function 202 may further include a sensing correlation identifier. The request may further include a list of sensing radio nodes identifiers, if available.

In step S13′, the AMF 122 may discover an LMF 105 and a sensing function 110 that serve the area of interest and supports the sensing event type(s) requested. This may include discovering the sensing function 110 via the NRF 120. The AMF 122 may then, in step S14′ select a sensing function 110 and the LMF 105 that serve at the area of interest and supports the sensing event type(s) requested. In an alternative embodiment, location management function and sensing function may be supported and provided by one function.

In step S15′, the AMF 122 may send a sensing request to the selected sensing function 110. The request may include the sensing measurement requirements received by the gateway function 202, such as the sensing requirement parameters. The request may further include the sensing correlation identifier that the AMF 122 may have assigned or received by the gateway function 202. If the sensing request in step S12′ includes a sensing radio node identifier then the AMF 122 may send separate request to the sensing function 110 per sensing radio node granularity.

If the request of step S15′ does not contain a SRN identifier, the sensing function 110 may determine and select the sensing radio nodes 124/126 that can provide a sensing event notification according to the sensing measurement requirements. In one embodiment the sensing radio nodes may have registered their sensing capabilities at the sensing function 110. Alternatively, the sensing function 110 may send a request to the sensing location register 118 to retrieve information on the available sensing radio nodes in the area of interest.

Thus, steps S17′ to S119′ may be an alternative procedure of discovering appropriate SRNs 126 in the area of interest and may therefore be optional. According to an embodiment, the selection may simply include using all SRNs 126 as discovered above. In another embodiment, the selection of step S11′ may include selecting the SRNs 126 based on their capabilities In an alternative embodiment, the sensing radio nodes may have registered their capabilities to the sensing function 110. In step S18′ the sensing location register 118 may retrieve the information on the SRNs (e.g. SRN 126 and/or RAN 124) that can assist in providing sensing measurement in the area of interest. The sensing location register 118 may respond with the requested information in step S19′.

After discovering the appropriate SRNs 126, i.e. either by the procedure of steps S17′ to S19′ or via other mechanisms, such as each SRNs 126 registering itself at the sensing function 110, or identification of the SRNs 126 at the gateway function 202, the sensing function 110 may select one or more SRNs 126 for providing a sensing measurement in step S20′. According to an embodiment, the selection may simply include using all SRNs 126 as discovered. In another embodiment, the selection may include selecting the SRNs 126 based on their capabilities. The SF 110 may in some embodiments further determine the configuration for the SRNs 126 and/or the selected RAN 124. The Configuration may be a radio pattern to monitor or use a specific AI model for tracing RF measurements.

In step 21, the AMF 122 may send a location request to the selected LMF 105. The request may include a new indication that a location measurement is needed only when a sensing event took place. The request may further comprise an area of interest and/or an accuracy of location measurement (e.g., horizontal and/or vertical accuracy requirements in meters). The request may also include the sensing correlation identifier that allows the sensing function 110 to correlate sensing and location measurements.

The LMF 105 may then send configuration information to the selected radio nodes 126 in step S22′. The configuration information may include information for the sensing radio nodes 124/126 to provide location related measurements only when a sensing even has taken place. The request may further include the sensing correlation identifier. In an embodiment, the request may be sent using the existing procedure defined in 3GPP TS 23.273.

In steps S23′ and S24′, the sensing function 110 may send a sensing monitoring request to each selected SRN 126 (and/or RAN 124). The request may include a specific ML model or the sensing type to report. The request may be sent to the sensing radio nodes 126 via control plane signaling via the AMF 122 or via user plane using a new protocol. Steps S23′ and S24′ may further include transmitting the corresponding configuration data determined in step S22′ to the respective one or more SRNs 124/126 that have been selected for sensing. In addition, the sensing function 110 may transmit the sensing correlation identifier to the selected SRNs 126.

After receiving the sensing monitoring request from the sensing function 110, the SRNs 126/124 may detect a sensing event of the specific event type in steps S25′ and/or S26′. This may include applying the configuration data received from the sensing function 110 and operating according to the configuration data.

In steps S27′ and S28′, the sensing radio nodes 124/126 may also perform location specific measurements if instructed by the LMF 105. As described above, the nodes 124/126 may be configured to perform the location measurement only if they identify a sensing event meeting the specific criteria. In steps S29′ and S30′, when the sensing radio nodes 124/126 identify a pattern that meets the criteria of the sensing event type, the sensing radio nodes 124/126 report the measurement to the sensing function. The sensing measurement may include the RF measurements collected. The information may further includes the sensing correlation identifier.

Likewise, the sensing radio nodes 124/126 may also provide location specific measurements to the LMF 105 in steps S31′ and S32′, if instructed by the LMF 105. The information may likewise include the sensing correlation identifier. Based on the received measurement, the LMF 105 may in step S33′ determine the location of the sensed object according to the location accuracy requirements. Thereafter, the LMF 105 may report the location of the sensed object to the AMF 122 in step S34′. The report may include the sensing correlation identifier received in step S21′.

In step S35′, the sensing function 110 may aggregate the sensing measurements from the selected sensing radio nodes 124/126. The sensing function 110 may be able to correlate all sensing measurements using the sensing correlation identifier. The sensing function 110 may validate that the reported sensing measurement(s) correspond to the sensing event type requested by the application function 112. The sensing function 110 may use an AI model to validate the sensing measurement(s). Alternatively, the validation and/or the aggregation may be performed by the gateway function 202.

According to an embodiment, the validation may refer to a confidence level of the sensing result. For example, if the validation results in a positive validation, the sensing event may be with a high certainty (such as 95%) of the sensing event type that has been specified in the sensing request. If the validation results in a negative validation, the confidence value may be lower, such as 50% or less.

In step S36′, the sensing function 110 may provide the sensing information to the AMF 122. The sensing information may include the sensing correlation identifier.

The AMF may then in Step S37′ aggregate the received sensing information and the received location information using the sensing correlation identifier and may then in step S38′ report the sensing information and the location information to the gateway function 202. Separate signaling may be used for sensing and location measurements, for example based on if separate requests were sent from the gateway function 202.

The report may in some embodiments further include the confidence level that has been determined in step S35′. The report in S38′ may further include an indication of accuracy of a location of the sensing event. Separate signaling may be used for sensing and location measurements, if separate requests (i.e. for location and sensing) were sent from the gateway function 202. The gateway function 202 may then provide the information to the application function 112 in step S39′ and the application function 112 may forward the information to the content provider 116 or the UE 114 in steps S40a′ and/or S40b′.

In alternative embodiments to the ones discussed above, the gateway function 202 may interface with a sensing location register (not shown) to discover sensing radio nodes in the area of interest. The sensing location register may be an LMF, AMF or UDM that has information on the location of the sensing radio nodes in the area, where sensing is requested. The request/interfacing may include an area of interest and a sensing event type. In an alternative embodiment, each sensing radio node 126 may register its sensing capabilities to the sensing location register 118. In such embodiment, once the identity of a sensing radio node 126 is retrieved, the gateway function 202 determines which sensing radio nodes 126 are in the area of interest as received in step S4 (S4′). The gateway function 202 may interface with the UDM to find the serving radio nodes 126 available in the area of interest.

As a further alternative embodiment for both scenarios (i.e. FIGS. 3a, 3b and FIGS. 4a, 4b), instead of a sensing location register 118, the sensing radio nodes 126 may registers their capabilities directly to the sensing function 110 using user plane signaling or the sensing radio nodes 126 may provide an indication to the AMF 122 during registration that the AMF 122 may forward to the sensing function 110 or the AMF 122 may store the sensing capabilities of each sensing radio node 126 and forward to the sensing function 110 when sensing a sensing request.

The above described features may be implemented as a computer-implemented method in a mobile telecommunications network. All the above described network functions may be computer functions that run on either on a standalone computer server that implements the corresponding functions or different network functions may share one or more computer servers. The computer server comprise respective computer hardware, such as at least one processor, at least one memory for saving computer-readable instructions that may be executed by the processor. The computer server may additionally comprise components for communicating with other computers or network devices, such as a network interface card.

1. A network apparatus for wireless communication, comprising:
at least one memory; and
at least one processor coupled with the at least one memory and configured to cause the network apparatus to:
receive a sensing request, the sensing request comprising sensing requirement parameters, the sensing requirement parameters comprising a sensing event type, a location area of interest, an indication to provide a location of the sensing event, and a corresponding location accuracy requirement;
transmit a sensing monitoring request for one or more sensing radio nodes to provide a sensing measurement based on the sensing event type, the sensing monitoring request comprising the sensing event type and a sensing correlation identifier;
transmit a location request for initiating location specific measurements in the location area of interest when the one or more sensing radio nodes identify a sensing event based on the sensing event type, the location request comprising the sensing correlation identifier and the location accuracy requirement;
aggregate sensing measurements from the one or more sensing radio nodes and location information based on location specific measurements from the one or more sensing radio nodes, wherein to aggregate the sensing measurements and location specific measurements the at least one processor is further configured to cause the network apparatus to correlate the sensing measurements and the location information based on the sensing correlation identifier;
validate that the sensing measurements correspond to the sensing event type; and
transmit a response based on the sensing measurements and the location information.

2. The network apparatus according to claim 1, wherein the at least one processor is further configured to cause the network apparatus to:
identify the one or more sensing radio nodes that comprise a sensing capability that meets the sensing requirement parameters and provides location measurements of the sensing event.

3. The mobile telecommunications network apparatus according to claim 2, wherein to identify the one or more sensing radio nodes the at least one processor is further configured to cause the network apparatus to transmit a request to a sensing location register, wherein the sensing location register is one of: a location management function (LMF), an access and mobility function (AMF), or a unified data management (UDM), or a standalone network function.

4. The network apparatus according to claim 2, wherein a sensing capability of each available sensing radio node is registered with the network apparatus for a specific location area of interest.

5. The network apparatus according to claim 1, wherein the at least one processor is further configured to cause the network apparatus to:
forward one or more of the sensing requirement parameters to an access and mobility function (AMF) or a gateway mobile location center (GMLC) for identifying a location management function (LMF) that serves the location area of interest.

6. The network apparatus according to claim 1, wherein the location request further comprises an indication that a location measurement is needed only if the sensing event type is measured in the location area of interest.

7. The network apparatus according to claim 1, wherein the at least one processor is further configured to cause the network apparatus sensing function being further configured to:
determine a sensing configuration for the one or more sensing radio nodes, wherein the sensing configuration comprises a radio pattern to monitor or uses an artificial intelligence (AI), model for tracing radio frequency (RF) measurements.

8. The network apparatus according to claim 1, wherein the sensing monitoring request uses an artificial intelligence (AI), AI, model for validating the sensing measurements.

9. The network apparatus according to claim 1, wherein the at least one processor is further configured to cause the network apparatus to:
discover a sensing function based on at least one of the sensing requirement parameters; and
transmit, based on discovering the sensing function, the sensing request to the sensing function.

10. A network apparatus for wireless communication, comprising:
at least one memory; and
at least one processor coupled with the at least one memory and configured to cause the network apparatus to:
receive a location request to provide a location specific measurement when one or more sensing radio nodes identify a sensing event based on a sensing event type, the location request comprising a sensing correlation identifier and a location accuracy requirement;
transmit location measurement instructions, the location measurement instructions comprising the sensing correlation identifier and the location accuracy requirement;
receive a location specific measurement for the one or more sensing radio nodes;
determine location information of a sensing event based on the location specific measurement and according to the location accuracy requirements;
transmit a response based on the location information, wherein the response comprises the sensing correlation identifier.

11. The network apparatus according to claim 10, wherein the network apparatus implements a location management function (LMF).

12. The network apparatus according to claim 10, wherein the at least one processor is further configured to cause the network apparatus to:
receive a sensing request, the sensing request comprising sensing requirement parameters, the sensing requirement parameters comprising the sensing event type, a location area of interest, an indication to provide a location of the sensing event, and a corresponding location accuracy requirement;
transmit a sensing monitoring request for one or more sensing radio nodes to provide a sensing measurement based on the sensing event type, the sensing monitoring request comprising the sensing event type and a sensing correlation identifier;
aggregate sensing measurements and location specific measurements from the one or more sensing radio nodes, wherein to aggregate the sensing measurements and location specific measurements the at least one processor is further configured to cause the network apparatus to correlate the sensing measurements and the location specific measurements based on the sensing correlation identifier;
validate that the sensing measurements correspond to the sensing event type; and
wherein the response is based on the sensing measurements and the location information.

13. The network apparatus according to claim 10, wherein the at least one processor is further configured to cause the network apparatus to receive the location request from a sensing function or a gateway mobile location center, like function, an access and mobility function (AMF), or a standalone location management function (LMF).

14. The network apparatus according to claim 10, wherein the at least one processor is further configured to cause the network apparatus to:
transmit configuration information, wherein the configuration information includes instructions for the one or more sensing radio nodes to provide location related measurements only if the sensing event type is measured.

15. A network apparatus for wireless communication, comprising:
at least one memory; and
at least one processor coupled with the at least one memory and configured to cause the network apparatus to:
receive a sensing request, the sensing request comprising sensing requirement parameters, the sensing requirement parameters comprising a sensing event type, a location area of interest, an indication to provide a location of the sensing event, and a corresponding location accuracy requirement;
discover a function for location management and a function for sensing that serve the location area of interest;
transmit a sensing monitoring request to provide a sensing measurement based on the sensing event type, the sensing monitoring request comprising the sensing event type and a sensing correlation identifier;
transmit a location request to provide a location specific measurement when one or more sensing radio nodes identify a sensing event based on the sensing event type, the location request comprising the sensing correlation identifier and the location accuracy requirement;
aggregate sensing information and location information, wherein to aggregate the sensing information and location information the at least one processor is further configured to cause the network apparatus to correlate the sensing measurements and the location information based on the sensing correlation identifier; and
transmit a response based on the sensing measurements and the location information.

16. The network apparatus according to claim 15, wherein the sensing request is received from a gateway function, and the response is transmitted to the gateway function.

17. The network apparatus according to claim 16, wherein the location request further comprises an indication that a location measurement is needed only if the sensing event type is measured in the location area of interest.

18. The network apparatus according to claim 15, wherein the sensing request and the location request are transmitted together as one request.

19. The network apparatus according to claim 15, wherein the function for location management and the function for sensing are a same network function.

20. (canceled)

21. A method performed by a network apparatus, the method comprising:
receiving a sensing request, the sensing request comprising sensing requirement parameters, the sensing requirement parameters comprising a sensing event type, a location area of interest, an indication to provide a location of the sensing event, and a corresponding location accuracy requirement;
transmitting a sensing monitoring request for one or more sensing radio nodes to provide a sensing measurement based on the sensing event type, the sensing monitoring request comprising the sensing event type and a sensing correlation identifier;
transmitting a location request for initiating location specific measurements in the location area of interest when the one or more sensing radio nodes identify a sensing event based on the sensing event type, the location request comprising the sensing correlation identifier and the location accuracy requirement;
aggregating sensing measurements from the one or more sensing radio nodes and location information based on location specific measurements from the one or more sensing radio nodes, wherein the aggregating comprises correlating the sensing measurements and the location information based on the sensing correlation identifier;
validating that the sensing measurements correspond to the sensing event type; and
transmitting a response based on the sensing measurements and the location information.
